(19) United States
(12) Patent Application Publication
(10) Pub. No.: US 2005/0027874 A1
(43) Pub. Date: Feb. 3, 2005

(54) Method for controlling upstream traffic in ethernet-based passive optical network

(76) Inventors: Su-Hyung Kim, Seoul (KR); Whan-Jin Sung, Suwon-si (KR); Ho-Il Oh, Seoul (KR); Young-Seok Kim, Seongnam-si (KR); Yun-Je Oh, Yongin-si (KR); Tae-Sung Park, Yongin-si (KR)

Correspondence Address: CHA & REITER, LLC, 210 ROUTE 4 EAST STE 103, PARAMUS, NJ, 07652, US

(21) Appl. No.: 10/776,727

(22) Filed: Feb. 11, 2004

(30) Foreign Application Priority Data
Jul. 29, 2003 (KR) 2003-52336

(51) Int. Cl. G06F 15/16

(52) U.S. Cl. 709/230

(57) ABSTRACT

A method for upstream traffic control in an Ethernet-based passive optical network, adapted for preventing a penalty phenomenon occurring in making upstream data transfer on basis of High Priority First Allocation (HPFA) algorithm. The method includes the steps of determining whether are any data frames to transfer in the first buffer; if it is determined that there are any data frames to transfer in the first buffer, determining whether the data frame does not exceed a low water mark indicative of a reference value set up to ensure the minimum transfer traffic; if it is determined that the data frame in the first buffer does not exceed the low water mark, then transferring the data frame stored in the first buffer and determining whether the data frame in a second buffer does not exceed the low water mark; if it is determined that the data frame in the second buffer does not exceed the low water mark, then determining whether the data frame to transfer in a third buffer does not exceed the low water mark; if it is determined that the data frame to transfer in the third buffer does not exceed the low water mark, then transferring the respective data frame stored in the second and third buffers.

### CLAIM OF PRIORITY

This application claims priority under 35 U.S.C. § 119 from an application entitled “Method for Controlling Upstream Traffic in Ethernet-based Passive Optical Network,” filed in the Korean Intellectual Property Office on Jul. 29, 2003 and assigned Serial No. 2003-52336, the contents of which are incorporated herein by reference.

### BACKGROUND OF THE INVENTION

1. Field of the Invention

The present invention generally relates to data transfer scheduling in an Ethernet-based passive optical network. More particularly, the present invention relates to a method for controlling data transfer scheduling for an optical network unit that supports a multiple service in an Ethernet-based passive optical network having an optical line terminal and a plurality of optical network units.

2. Description of the Related Art

A passive optical network is one type of optical communication network system adapted to deliver data communication signals to an end-user through a fiber optic cable network. In general, such a network comprises an optical line terminal (OLT) located at a telecommunication company and a plurality of optical network units (ONU) arranged in the vicinity of each subscriber, wherein the optical line terminal (OLT) is usually designed to be connectable up to a maximum of 32 optical network units. The passive optical network is normally allowed to provide its users with up to 622 Mbps of downstream bandwidth and up to 155 Mbps of upstream bandwidth in its single stand-alone system. The bandwidth (both upstream and downstream) may be assigned to a plurality of end-users in the passive optical network. Further, the passive optical network can be used as a trunk between a large-scale system, such as a cable TV network system, and a nearby building or a home Ethernet network using coaxial cables.

In contrast to the passive optical network, an active optical network unit is designed to provide its subscribers with active service in response to the subscriber's needs. The optical line terminal (OLT) permits the forwarding of various service data to the predetermined optical network units (ONU) via a fiber optic cable, so that the predetermined ONU that receive the service data from the OLT subsequently carry out signal processing that allows the transfer of the data to the end-user.

The optical network unit (ONU), which constitutes a transmission system in the subscriber's side, is often defined as terminal equipment in an optical communication network that provides the end-user with a service interface. This ONU is usually implemented to accommodate various fiber optics such as FTTC (Fiber To The Curb), FTTB (Fiber To The Building), FTTF (Fiber To The Floor), FTTH (Fiber To The Home), FTTO (Fiber To The Office), etc., so that it has high service accessibility to those subscribers. The ONU serves to connect a cable for transmission of an analog signal sent from the subscribers with optical devices and equipments for receiving and transmitting an optical signal to/from the OLT. Thus, the ONU functions as an optical-to-electrical conversion means for converting the optical signal from the OLT to the electrical signal, or as an electrical-to-optical conversion means for converting the electrical signal form the subscriber to optical signal for transfer to the OLT.

FIG. 1 illustrates one way that an upstream data transfer structure may operate in a Gigabit Ethernet passive optical network system, while FIG. 2 illustrates a downstream data transfer structure in the Gigabit Ethernet passive optical network system. As shown in the drawings, the passive optical network system is configured in such a manner that one OLT 10 is tree-connected with a plurality of ONUs (20, 22 and 24) via an optical splitter/combiner 15, which system efficiently provides a method for implementing more economic network system than an AON (Activity-On-Node) system.

An earlier type of the passive optical network system includes an asynchronous transfer mode passive optical network (referred to as “ATM-PON”), which became a technical standard in the art, wherein the ATM-PON performs upstream and downstream transmission in the form of blocks, each of the blocks binding a plurality of ATM cells in a fixed size. On the other hand, the above Ethernet passive optical network (referred to as “E-PON”) system performs upstream and downstream transmission in the form of block binding into a fixed block size with a plurality of packets each having different size. Hence, such an E-PON scheme generally is more complicated structure than an ATM-PON scheme.

Referring now to FIG. 1, upstream data transfer will be described. In traffic control for upstream, each data transmitted from respective users (30, 32 and 34) is transferred to a respective ONU (20, 22 and 24), wherein in turn each of the respective ONUs (20, 22 and 24) transfers to the optical splitter 15 data transmitted from the users in accordance with a predetermined condition for transfer approval defined in the OLT 10, wherein the ONUs perform upstream transmission on the received data by time division multiplexing (TDM). Therefore, there occurs no data collision according to upstream data transfer in the optical splitter 15. A predetermined a mount of the data from each respective ONU is combined by the splitter 15 into an IEEE 802.3 frame, with each frame having a header, payload and error code.

Referring now to FIG. 2, downstream data transfer will be described hereinafter. In traffic control for downstream, the OLT 10 broadcasts each data to be transmitted to the ONU (20, 22 and 24), and the optical splitter 15 then distributes the data received from the OLT 10 to each ONU (20, 22 and 24). The respective ONU detects user data to be transferred to each user (30, 32 and 34) from the received data and subsequently transfers only the detected data to each designated user. The OLT broadcast can be in the format of an IEEE 802.e Frame as shown, having a head, payload and error code.

The ONUs utilize a High Priority First Allocation (HPFA) algorithm that decides transfer priority using a queue upon data transfer. This HPFA algorithm would contribute to an increase in band occupation (use rate) by reducing the remaining bands resulting from solving of a Head of Line (HOL) blocking problem. The term “HOL” generally refers to the lost use of an allocated band generated when a buffer receives an amount of data that is less than what is considered an acceptable amount of data corresponding to the allocated band. The HOL blocking problem will lead to deterioration in overall transfer efficiency of the E-PON as the problem significantly diminishes the amount of data processing in upstream transmission for the ONU (20, 22, 24).

The above HPFA algorithm operates to allocate a band of the highest priority queue within the allocated bands when the ONUs allocate to each queue the band allocated from the OLT 10. Here, in case that there exist any remaining bands after allocation of bands for the higher priority queue, the ONUs (20, 22, 24) determine a new request band in consideration of the requested band of each queue and its relative weight. Based on this determination, the ONUs allocate the band for each queue in the order of the number of requests made by those queues. This HPFA algorithm operates so that it first allocates the band for the higher priority queue, so it will meet the requirements for each service in an efficient manor. Further, because the HPFA algorithm operates to allocate only the band requested from the queue, it will also provide the lower priority queue with an opportunity for transfer, thereby ensuring the fairness between respective queues.

In the meantime, in case that the ONU applies the HPFA algorithm in a data transfer, the band from the higher priority queue is first allocated to ensure the data transfer. Hence, there is a disadvantage in that the delay in lower priority queues further increases despite the low input load. This increase in delay is a phenomenon that is referred to as a “penalty phenomenon” in the low input load in this field of the art. This problem mostly occurs owing to the condition that in the timing point of transferring the data of higher priority queue is first secured to transfer.

Further, in case the ONU (20, 22 or 24) carries out the data transfer using the existing HPFA algorithm, it does not consider the FIFO (First-in First-out) system, but takes into account only the higher priority and the lower priority for queues to determine the band allocation for data transfer (i.e. scheduling of transfer). Therefore, since the ONUs transfer a series of data by use of the HPFA algorithm making a decision about the scheduling of data transfer in consideration of a priority only upon band allocation for the queues, the data transfer complying with the FIFO system could not be secured for the lower priority queues in a stable manner.

FIG. 3 illustrates a basic block diagram representing a scheduling scheme for data transfer traffic control in conventional system. The ONU (20, 22, 24) operates to inform its own location and presence with registration to the OLT 10, and it is then assigned a respective ONU identification (ID). The OLT 10 grants an opportunity capable of transferring data to those ONUs by means of an upstream data transferring grant frame. Those ONUs (20, 22, 24) each have a scheduler (20a, 22a, 26a) for controlling the traffic for upstream data transfer, so that the respective scheduler (20a, 22a, 26a) arranged within the respective ONUs makes a measurement for an amount of data kept in queues (21a, 21b, 21c, 23a, 23b, 23c, 27a, 27b, 27c) prepared in the ONUs buffering data for transfer. The ONUs (20, 22, 24) each control the input into a bandwidth allocation request frame the respective queue values measured by the scheduler (20a, 22a, 26a), for transferring the frame to the OLT 10.

The upstream data transferring grant frame is a type of downstream packet used in the case where the OLT 10 grants the ONUs (20, 22, 24) an opportunity for enabling upstream data transfer, while the bandwidth allocation request frame is a type of upstream packet used in the case where the ONUs (20, 22, 24) are to request bandwidth allocation to the OLT 10 with approval of the OLT 10.

Once the OLT 10 receives a bandwidth request from those ONUs, the scheduler 12 of the OLT is controlled to allocate any suitable data transfer bandwidth to the ONUs. Then, the OLT 10 operates to incorporate this result into an upstream data transferring grant frame of a subsequent time slot to transfer it to the ONUs (20, 22, 24). Here, the allocation information, being comprised of a transfer starting time and a transfer keeping time, is received by the ONUs which in turn serve to transfer the data to the OLT 10 for a granted time duration at an assigned timing point.

In the meantime, the schedulers (20a, 22a, 26a) disposed in the ONUs (20, 22, 24) respectively perform a scheduling for upstream traffic that determines by which order the data in queues (21a, 21b, 21c, 23a, 23b, 23c, 27a, 27b, 27c) are to be transferred at any assigned times. At this time, the schedulers (20a, 22a, 26a) determine a data transfer schedule by taking into account only the higher or lower priorities for the queues; in contrast, in a the FIFO system, the data transfer schedule functions as “first-in, first-out” as time changes. Therefore, such a scheduling system using the prior art upstream transmission traffic control often renders a disadvantage in that stable data transfer may not be efficiently secured for the lower priority of queues.

### SUMMARY OF THE INVENTION

It is an object of the present invention to overcome the aforementioned disadvantage by providing a method for upstream traffic control in an Ethernet-based passive optical network that is prevent a penalty phenomenon occurring in effecting upstream data transfer on basis of High Priority First Allocation (HPFA) algorithm.

Yet another object of the present invention is to provide a method for upstream traffic control in an Ethernet-based passive optical network, capable of achieving a more efficient upstream data transfer than using the allowed queue resources in a most effective way, while taking into account the service characteristics required to data streams for upstream transmission.

In order to achieve the above and other objects of the present invention, the method for upstream traffic control for data frames in association with a plurality of buffers including at least a first, a second and a third buffer with a predetermined priority in transfer based upon a service characteristic required in an Ethernet-based passive optical network, includes the steps of:
(a) determining whether there is any data frame to transfer in the first buffer;
(b) if it is determined in step (a) that there is a data frame to transfer in the first buffer, determining whether the data frame does not exceed a low water mark indicative of a reference value set up to ensure the minimum transfer traffic;
(c) if it is determined in step (b) that the data frame in the first buffer does not exceed the low water mark, controlling to transfer the data frame stored in the first buffer and determining whether the data frame in a second buffer does not exceed the low water mark;
(d) if it is determined in step (c) that the data frame in the second buffer does not exceed the low water mark, then determining whether the data frame to transfer in a third buffer does not exceed the low water mark; and
(e) if it is determined in step (d) that the data frame to transfer in the third buffer does not exceed the low water mark, then controlling to transfer the respective data frame stored in the second and third buffers.

Preferably, the method for upstream traffic control according to the present invention further includes the step of checking the size of data frames stored in the second and third buffers referring to the low water mark, and determining whether the transfer of the data frame is to be effected, if it has been determined that there is not a data frame to transfer in the first buffer in the step (a).

The method for upstream traffic control according to the present invention further includes the step of controlling to transfer all the data frames stored in the first buffer, if it is determined that the data frame stored in the first buffer does exceed the low water mark in the step (b).

Preferably, the method for upstream traffic control according to the present invention further includes the steps of determining whether the data frame in the first buffer does not exceed the low water mark, if it is determined that the data frame stored in the second buffer does exceed the low water in the step (c), and controlling to transfer the data frames stored in the second buffer, if it is determined that the data frame stored in the first buffer does not exceed the low water mark.

More preferably, the method for upstream traffic control according to the present invention further includes the steps of controlling to first transfer the data frames stored in the first buffer and then in the second buffer, if it is determined that the data frame stored in the first buffer does exceed the low water mark.

More preferably, the method for upstream traffic control according to the present invention further includes the steps of determining whether the data frame in the first buffer does not exceed the low water mark, if it is determined that the data frame stored in the third buffer does exceed the low water in the step (d), and controlling to transfer the data frame stored in the third buffer, if it is determined that the data frame stored in the first buffer does not exceed the low water mark.

Preferably, the method for upstream traffic control according to the present invention further includes the step of first transferring the data frames stored in the first buffer and then in the third buffer, if it is determined that the data frame stored in the first buffer does exceed the low water.

According to the present invention, it is preferred that the data frames stored in the first buffer include video data frames, the data frames stored in the second buffer include audio data frames, and the data frames stored in the third buffer include character data frame.

More preferably, according to the method for upstream traffic control in Ethernet-based passive optical network of the present invention, in the course of transferring the data frames stored in the second and/or third buffer, if the data frame existing in the first buffer does exceed the low water mark, then the transference of the data frames stored in the second and/or third buffer is interrupted and instead transferring of the data frame stored in the first buffer with highest priority is effected.

According to the present invention a comparison is made to the amount of data frames stored in a respective buffer and a predetermined low water mark (M) set for the buffer as well as to the priority in between the data frames. This comparison is made so that in case the data frame in the buffer exceeds the low water mark, the scheduler first transfers the data frame stored in the buffer even though the data frame has a low priority to transfer. This operation will make it possible to ensure the transfer priority allowed for the associated data frame while it uses all the allowed buffer resources efficiently.

Furthermore, the present invention permits determining the order of data transfer, and on the basis of such determination, performs a scheduling for upstream traffic control. While determining the order of transfer and performance of upstream traffic scheduling is taking place, there is a taking into the data storage capacity to ensure the minimum transfer traffic allowed, as well as the priority for the queues according to the required service characteristics relative to the respective data frames. The aforementioned results in that all of the traffic situation for queues can be efficiently considered during the data transfer in the Ethernet-based passive optical network system. Accordingly, more efficient use and upstream transmission for all the queue resource allowed will be achieved.

### BRIEF DESCRIPTION OF THE DRAWINGS

The foregoing and other features and advantages of the invention will be apparent from the following detailed description of preferred embodiments as illustrated in the accompanying drawings, wherein same reference characters refer to the same parts or components throughout the various views. The drawings are not necessarily to scale, but the emphasis instead is placed upon illustrating the principles of the invention, wherein:

FIG. 1 schematically illustrates an upstream transmission scheme of data in an Ethernet-based passive optical network;

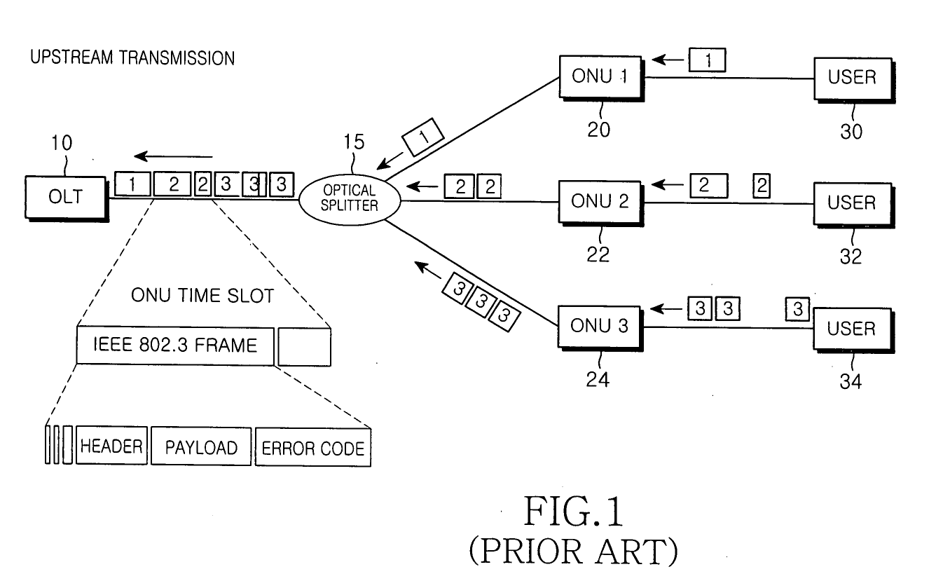

FIG. 2 schematically illustrates a downstream transmission scheme of data in a Gigabit Ethernet-based passive optical network;

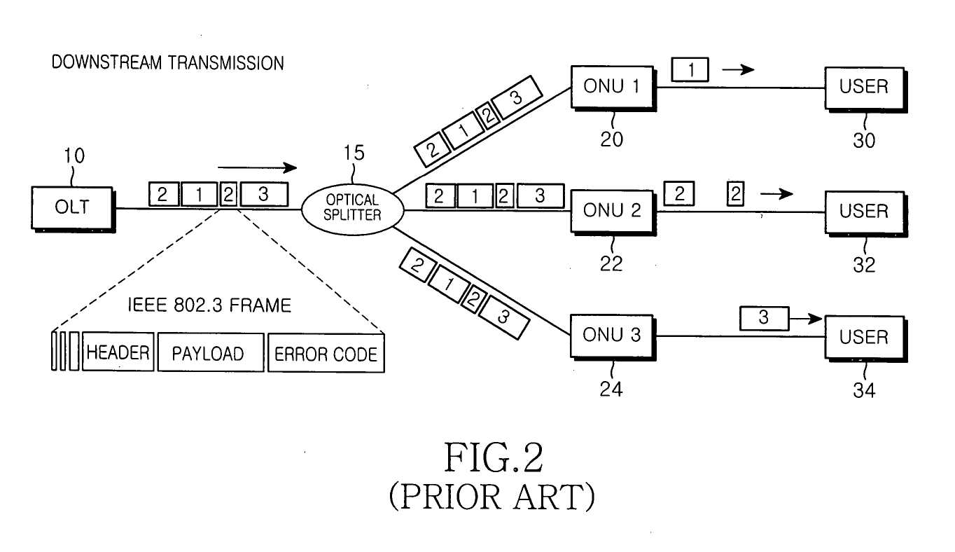

FIG. 3 schematically illustrates a basic block diagram of an Ethernet-based passive optical network system representing a scheduling for a prior art data transfer traffic control;

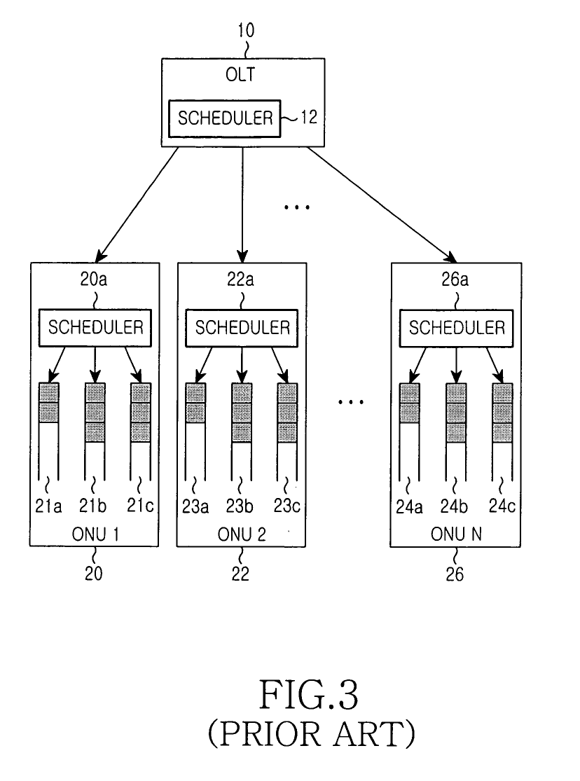

FIG. 4 schematically illustrates a block diagram of a preferred embodiment for an Ethernet-based passive optical network system controlling a scheduling of upstream data traffic by using a low water mark according to the present invention;

FIG. 5 schematically illustrates a more detailed block diagram of an optical network unit (ONU 1) in FIG. 4;

FIG. 6 illustrates a schematic block diagram of an optical network unit (ONU 1) controlling traffic of each buffer for upstream transmission of data frames in FIGS. 4 and 5; and

FIG. 7 schematically illustrates a flow chart diagram according to a preferred embodiment of an upstream traffic control method in an Ethernet-based passive optical network system according to the present invention.

### DETAILED DESCRIPTION OF THE PREFERRED EMBODIMENT

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. For the purpose of simplicity and clarity, detailed descriptions of well-known devices and methods are omitted so as not to obscure the description of the present invention with unnecessary detail.

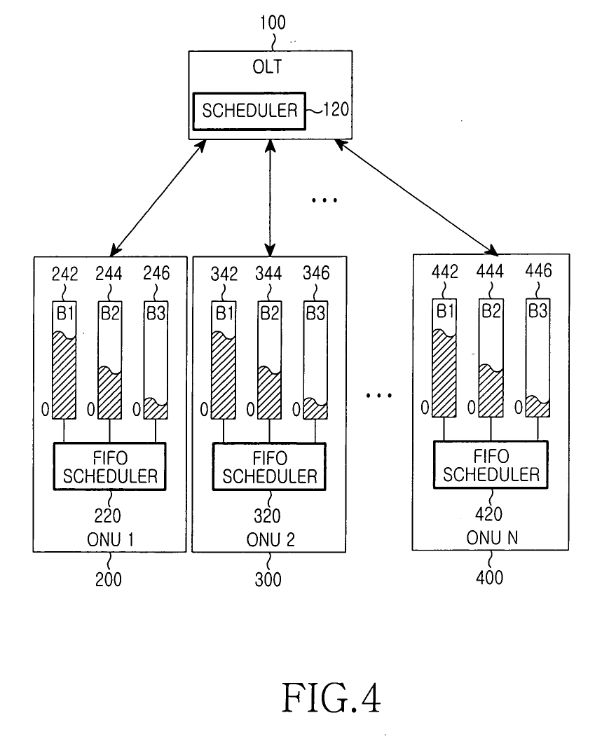

FIG. 4 illustrates an aspect of the present invention whereby an Ethernet-based passive optical network system in which a scheduling of upstream data traffic is controlled using a low water mark. As shown in the drawing, the Ethernet-based passive optical network system is comprised of an optical line terminal (OLT) 100 and a plurality of optical network units (ONUs) 200, 300 and 400. The OLT 100 is provided with a scheduler 120 for allocation of data transfer of these ONUs. Further, each ONU (200, 300, 400) is provided with a FIFO (First-in First-out) scheduler (220, 320 or 420) for setting-up a transfer schedule for data frames in each queue, that is, a respective buffer (242, 244, 246, 342, 344, 346, 442, 444, 446) arranged within the ONUs.

The FIFO schedulers (220, 320, 420) arranged in the ONUs (200, 300,400) utilize a round robin system based on the High Priority First Allocation (HPFA) algorithm to perform a FIFO scheduling for those buffers (242, 244, 246, 342, 344, 346, 442, 444, 446) in sequence. A person of ordinary skill in the art will appreciate that the data frames inputted to buffers B1 (242, 342, 442) include data with higher priority than the data frames inputted to buffers B2 (244, 344, 444) and buffers B3 (246, 346, 446). When such a priority is applied, it is preferable to configure so that the buffers B1 (242, 342, 442) are used as buffers for voice data, the buffers B2 (244, 344, 444) for video data and the buffers B3 (246, 346, 446) for character data, respectively.

The FIFO schedulers (220, 320, 420) perform the FIFO scheduling while taking into account the HPFA algorithm is controlled to determine, first of all, whether there is a data frame existing in the highest priority buffers B1 (242, 342, 442) or not. If it is determined that there not a data frame that exists in the highest priority buffers B1 (242, 342, 442), then the FIFO scheduler monitors whether or not any data frame is inputted to in the buffers B1 (242, 342, 442). However, it is determined that any data frame exists in the highest priority buffers B1 (242, 342, 442), then the FIFO schedulers (220, 320, 420) each perform a suitable scheduling for upstream traffic control in order to transfer the data frame with the priority.

In case the data frame provided in the buffers B1 (242, 342, 442) exceeds a predetermined low water mark (M), the FIFO schedulers (220, 320, 420) control the transfer of all the data frames in the buffers B1 (242, 342, 442), and then perform a scheduling for upstream transmission relative to the buffers B2 (244, 344, 444) and the buffers B3 (246, 346, 446). Even if the data frame existing in the buffers B1 (242, 342, 442) does not exceed the low water mark (M), the FIFO schedulers (220, 320, 420) control the transfer of all the data frames existing at the moment while taking into account the priority characteristics from the data to be inputted to the buffers B1 (242, 342, 442) and then perform a scheduling for upstream transmission relative to the data frames existing in the buffers B2 (244, 344, 444) and the buffers B3 (246, 346, 446).

Further, if it is determined that the data frame provided in the buffers B2 (244, 344, 444) and the buffers B3 (246, 346, 446) is equal to or exceeds the low water mark (M), then the FIFO schedulers (220, 320, 420) control the unconditional transfer all the data frames in the buffers B2 (244, 344, 444) and the buffers B3 (246, 346, 446) so that the data frame in the buffers B1 (242, 342, 442) is no higher than the low water mark (M). That is to say, even if the data frame existing in the buffers B2 (244, 344, 444) and the buffers B3 (246, 346, 446) were equal to or would exceed the low water mark (M), the FIFO schedulers (220, 320, 420) would control the transfer of all the data frames existing in the buffers B1 (242, 342, 442) in case it is determined that the data frame provided in the buffers B1 (242, 342, 442) is equal to or exceeds the low water mark (M).

If it is determined that the data frame existing in the buffers B2 (244, 344, 444) and the buffers B3 (246, 346, 446) is equal to or below the low water mark (M), then the FIFO schedulers (220, 320, 420) control the comparison of the low water mark relative to every buffer with a data frame in each buffer and then perform a scheduling according to its result, subsequently carrying out re-scheduling from the buffers B1 (242, 342, 442).

Accordingly, a person or ordinary skill in the art appreciates that by transferring data frames, due consideration can be made with a view to more efficient use of the buffer resources, as well as ensuring the priority of data frames in the buffers, with comparing the low water mark preset relative to each buffer with an amount of data frames in the buffer and, according to a result of the comparing, by first transferring the data frames existing in the associated buffer whenever the data frames in the buffers are equal to or exceed the low water mark, even though they are comparatively low priority of data frames.

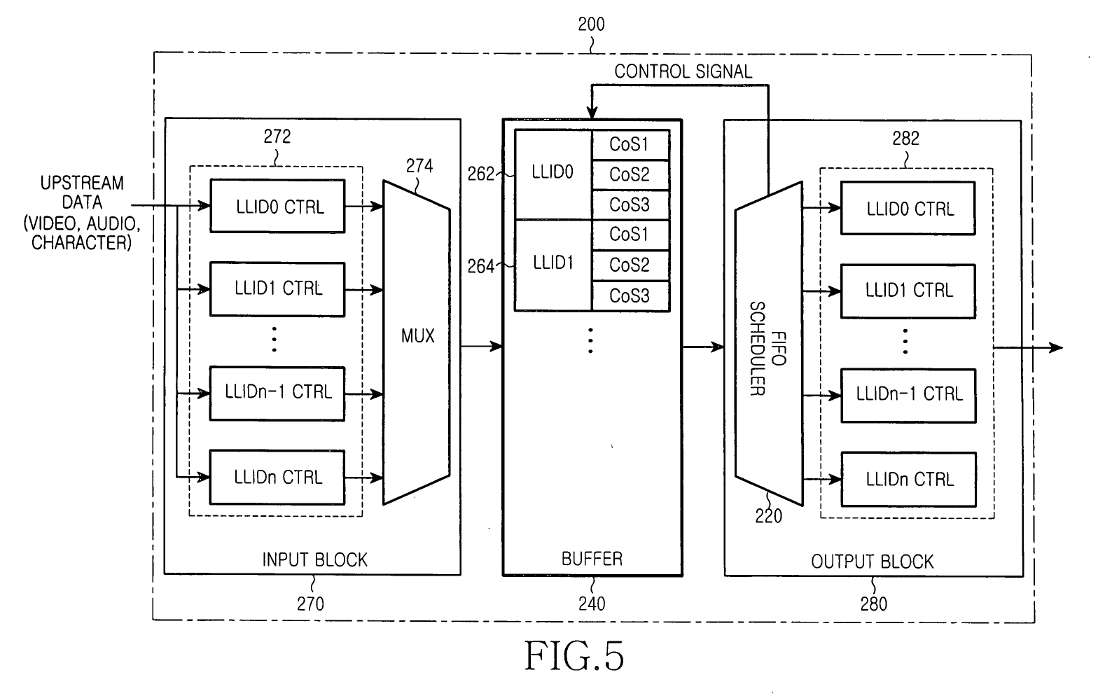

Referring now to FIG. 5, detailed description will be made to a block diagram of an optical network unit (ONU) 200 shown in FIG. 4. The optical network unit (ONU) 200 has an input block 270, a buffer 240 and an output block 280. The input block 200 includes a divider section 272 and a multiplexer 274. The divider section 272 serves to classify the upstream transmission data such as video, audio and character data inputted for upstream transmission, according to a logical link identification (LLID). The multiplexer 274 arranges into series the upstream transmission data classified according to LLID for outputting to the buffer section 240. The buffer section 240 stores the classified upstream transmission data into a plurality of buffers provided according to LLIDs (262, 264, . . . ) in it.

The output block 280 includes a FIFO scheduler 220 and a synthesizer section 282, wherein the FIFO scheduler 220 is adapted to control the output of the buffer 240 through a control signal served according to a preferred embodiment of the present invention and to output in parallel the data frames received from the buffer 240, according to each LLID. The synthesizer section 282 combines the data frames each inputted according to each LLID for delivery to the OLT 100 through an associated transfer channel.

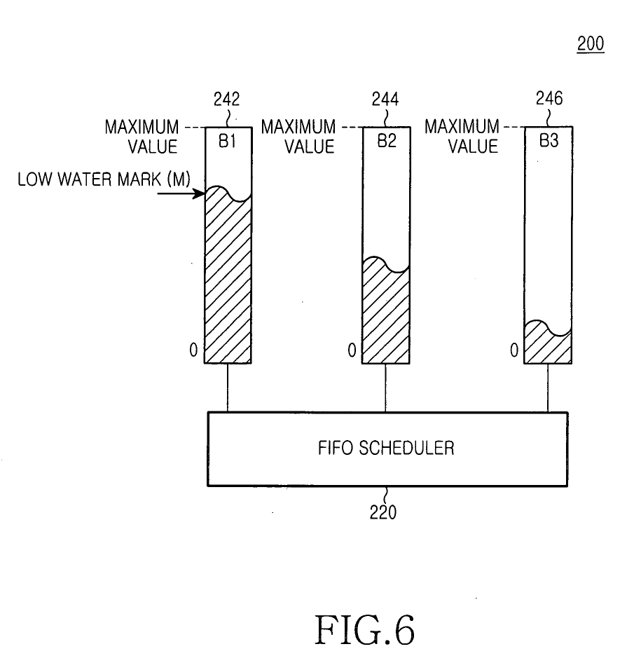

Referring then to FIG. 6, it is described a block diagram of an optical network unit (ONU) 200 controlling traffic of each buffer for upstream transmission of data frames in FIGS. 4 and 5. According to HPFA algorithm using the low water mark (M) of the preferred embodiment, the FIFO scheduler 220 controls the set up of the low water mark in each queue for the respective buffers B1 (242, 244, 246), in accordance with the kind of data frames for buffering. Here, the low water mark (M) is referred to as a maximum storage capacity in the buffer that is to set up to maintain the minimum traffic in transferring data frames, which may be also defined as a kind of storage threshold value for each buffer. Therefore, the low water mark (M) will be defined as an intermediate value between the minimum value (zero) and the maximum value in the respective buffers (242, 244, 246) according to the required service contents in the data frames.

Describing in further detail, if the high priority of data frame stored in the buffer B1 (242) does not exceed a predetermined low water mark (M), the FIFO scheduler 220 compares the buffers B2 and B3 (244, 246) storing the low priority of data frame with the low water mark. As a result of it, if it is determined that the data frames stored in the buffers B2 and B3 (244, 246) are equal to or exceed the low water mark, then the FIFO scheduler 220 controls the buffers B2 and B3 (244, 246) so as to transfer the data frames stored in these buffers B2 and B3 (244, 246). In the meantime, while transferring the data frames inputted in the buffers B2 and B3 (244, 246) with the lower priority, if the higher priority of data frames inputted to the buffer B1 (242) are equal to or exceed the low water mark, then the FIFO scheduler 220 discontinues the transferring of the data frames for the lower priority of buffers B2 and B3 (244, 246) and instead undertakes the transfer of the data frames stored in the higher priority of buffer B1 (242).

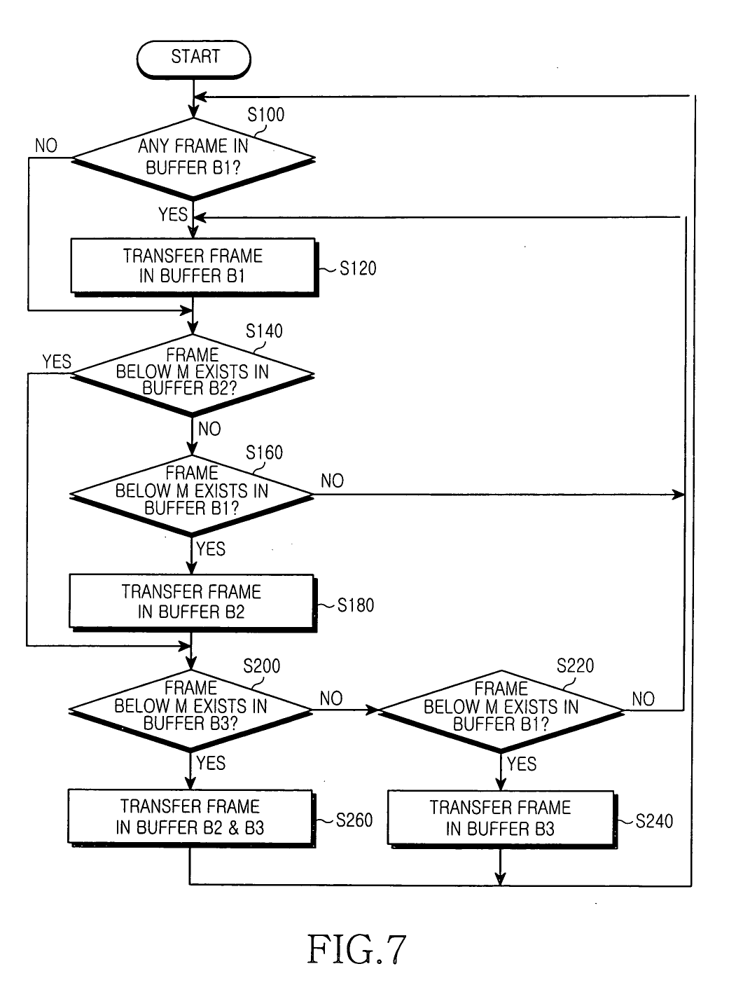

FIG. 7 schematically illustrates a flow chart of a preferred embodiment for an upstream traffic control method in an Ethernet-based passive optical network system according to the present invention. For the sake of convenience in explanation, the following description will be made with reference to one ONU 200 as shown in FIGS. 4 to 6 although the number of ONUs coupled to the OLT 100 is plural. However, it is appreciated that the upstream traffic control method described below may be similarly implemented relative to any ONUs coupled to the OLT 100.

As shown in the drawings, the FIFO scheduler 220 determines whether there is a data frame that needs to be transferred in the buffer B1 (242) with higher priority. If it is determined that there is a data frame to be transferred in the buffer B1 (242) with priority, the FIFO scheduler 220 first transfers the data frame stored in the buffer B1 (242), in step S120. After transferring the data frame stored in the buffer B1 (242), if it is determined that there is no other data frame that needs to be transferred in the buffer B1 (242), then the FIFO scheduler 220 determines whether or not there are any data frames to be transferred in the buffer B2 (244). If it is determined that there are any data frames to be transferred in the buffer B2 (244), then the FIFO scheduler 220 in step S140 determines whether or not the data frame exists below the low water mark (M) set to ensure the minimum traffic of the transfer frames between a maximum value of buffer and a minimum value of buffer.

If it is then determined that there are any data frames in the buffer B2 (244) below the low water mark, then the FIFO scheduler 220 determines whether or not there exists any data frame to be transferred in the buffer B3 (246). As a result, if it is determined that there are any data frames to be transferred in the buffer B3 (246), then the FIFO scheduler 220 determines, in step S200, whether or not the data frame exists below the low water mark (M). Consequently, if it is determined that there is a data frame in the buffer B3 (246) below the low water mark (M), the FIFO scheduler 220 transfers the data frames in both the buffers B2 and B3 (244, 246), in step S260, and then reiterates the previous control steps S100 to S260.

Meanwhile, if it is determined in the step S140 that the data frame in the buffer B2 (244) exists above the low water mark, then the FIFO scheduler 220 determines whether or not there is a data frame in the buffer B1 (242) below the low water mark. Therefore, if it is determined that there is a data frame in the buffer B1 (242) below the low water mark (M), the FIFO scheduler 220 transfers the data frame in the buffer B2 (244), in the step S180. However, if it is determined that the data frame in the buffer B1 (242) exists above the low water mark (M) other than below the low water mark, then the FIFO scheduler 220 performs the step S120 to transfer the data frame in the buffer B1 (242).

In a similar manner, if it is determined in the step S200 that there is a data frame in the buffer B3 (246) above the low water mark, then the FIFO scheduler 220 determines whether or not there is a data frame in the buffer B1 (242) exists below the low water mark (M), in step S220. Therefore, if it is determined that there is a data frame in the buffer B1 (242) below the low water mark (M), the FIFO scheduler 220 transfers the data frame in the buffer B3 (246), in the step S240. However, if it is determined that the data frame in the buffer B1 (242) exists above the low water mark (M) other than below the low water mark, then the FIFO scheduler 220 performs the step S120 to transfer the data frame in the buffer B1 (242).

As a result, it will be appreciated that the scheduler according to the present invention is adapted for determining the order of data transfer and on the basis of such determination, performing a scheduling for upstream traffic control, while taking into the data storage capacity to ensure the minimum transfer traffic allowed, as well as the priority for the queues according to the required service characteristics relative to the respective data frames, so that all the traffic situation for queues can be efficiently considered during the data transfer in the Ethernet-based passive optical network system. Accordingly, more efficient use and upstream transmission for all the queue resource allowed will be achieved.

As apparent from the foregoing description, according to the present invention, it will be understood that a comparison is made to the amount of data frames stored in a respective buffer and a predetermined low water mark (M) set for the buffer, in addition to the priority in between the data frames, so that in case the data frame in the buffer exceeds the low water mark, the scheduler first transfers the data frame stored in the buffer even though the data frame has a low priority to transfer. This operation will make it possible to ensure the transfer priority allowed for the associated data frame while it uses all the allowed buffer resources efficiently.

While the preferred embodiments of the present invention have been illustrated and described, it will be understood by those skilled in the art that various changes and modifications may be made, and equivalents may be substituted for elements thereof without departing from the true scope of the present invention. Therefore, it is intended that the present invention not be limited to the particular embodiment disclosed as the best mode contemplated for carrying out the present invention; instead, it is intended that the present invention include all embodiments falling within the scope of the appended claims.

1. A method for upstream traffic control for data frames in association with a plurality of buffers including at least a first, a second and a third buffer with a predetermined priority in transfer based upon service characteristic required in an Ethernet-based passive optical network, the method comprising the steps of:
(a) determining whether there is at least one data frame to transfer in the first buffer;
(b) if it is determined in step (a) that there is a data frame to transfer in the first buffer, determining whether the data frame does not exceed a low water mark indicative of a reference value set up to ensure the minimum transfer traffic;
(c) if it is determined in step (b) that the data frame in the first buffer does not exceed the low water mark, transferring the data frame stored in the first buffer and determining whether the data frame in a second buffer does not exceed the low water mark;
(d) if it is determined in step (c) that the data frame in the second buffer does not exceed the low water mark, then determining whether there is a data frame to transfer in a third buffer does not exceed the low water mark;
(e) if it is determined in step (d) that the data frame to transfer in the third buffer does not exceed the low water mark, then transferring the respective data frames stored in the second and third buffers.

2. The method for upstream traffic control in Ethernet-based passive optical network according to claim 1, further comprising the step of checking a size of data frames stored in the second and third buffers referring to the low water mark, and determining whether the transfer of the data frame is to be effected, if it is determined that there is no data frame to transfer in the first buffer in the step (a).

3. The method for upstream traffic control in Ethernet-based passive optical network according to claim 1, further comprising the step of transferring all the data frames stored in the first buffer, if it is determined that the data frame stored in the first buffer does exceed the low water mark in the step (b).

4. The method for upstream traffic control in Ethernet-based passive optical network according to claim 1, further comprising the steps of determining whether the data frame in the first buffer does not exceed the low water mark, if it is determined that the data frame stored in the second buffer does exceed the low water in the step (c), and transferring the data frames stored in the second buffer, if it is determined that the data frame stored in the first buffer does not exceed the low water mark.

5. The method for upstream traffic control in Ethernet-based passive optical network according to claim 4, further comprising the steps of first transferring the data frames stored in the first buffer and then in the second buffer, if it is determined that the data frame stored in the first buffer does exceed the low water mark.

6. The method for upstream traffic control in Ethernet-based passive optical network according to claim 1, further comprising the steps of determining whether the data frame in the first buffer does not exceed the low water mark, if it is determined that the data frame stored in the third buffer does exceed the low water in the step (d), and transferring the data frame stored in the third buffer, if it is determined that the data frame stored in the first buffer does not exceed the low water mark.

7. The method for upstream traffic control in Ethernet-based passive optical network according to claim 6, further comprising the step of first transferring the data frames stored in the first buffer and then in the third buffer, if it is determined that the data frame stored in the first buffer does exceed the low water.

8. The method for upstream traffic control in Ethernet-based passive optical network according to claim 1, wherein the data frames stored in the first buffer include video data frames, the data frames stored in the second buffer include audio data frames, and the data frames stored in the third buffer include character data frame.

9. The method for upstream traffic control in Ethernet-based passive optical network according to claim 1, wherein in the course of transferring the data frames stored in the second and/or third buffer, if the data frame in the first buffer does exceed the low water mark, then transferring of the data frames stored in the second and/or third buffer is interrupted and a transfer of the data frame stored in the first buffer with highest priority is effected.
